(19) United States
(12) Patent Application Publication
(10) Pub. No.: US 2016/0189563 A1
(43) Pub. Date: Jun. 30, 2016

(54) EDUCATIONAL SYSTEM WITH REAL TIME BEHAVIOR TRACKING

(71) Applicants: Moshe FRIED, Brooklyn, NY (US); Solomon FRIED, Woodmere, NY (US)

(72) Inventors: Moshe FRIED, Brooklyn, NY (US); Solomon FRIED, Woodmere, NY (US)

(21) Appl. No.: 14/979,958

(22) Filed: Dec. 28, 2015

Related U.S. Application Data
(60) Provisional application No. 62/097,051, filed on Dec. 27, 2014.

(51) Int. Cl. G09B 19/00

(52) U.S. Cl. CPC G09B 19/00

(57) ABSTRACT

A computer program product for capturing real time behavior patterns of individual students to track the students progress and development of his/her true potential, the computer program product comprising a tangible computer readable storage medium having computer readable program embodied therein, the computer readable program code configured to: a first interface with the layout of a classroom and students; a second interface with attendance indicators; a third interface with academic indicators; and a fourth interface with behavior indicators; wherein the second interface, third interface and fourth interface are in communication with the first interface such that the real time behavior patterns of the attendance, academic and behavior indicators of the individual students in the classroom are captured and complex output of the real time behavior patterns is generated to track the students progress.

This application claims the benefit of U.S. provisional application no. 62/097/051 filed Dec. 27, 2014, which is incorporated herein in its entirety by reference.

### FIELD OF THE INVENTION

The present invention provides a system for assisting educators in better understanding each individual student's needs and learning processes. The invention systems enable educators to generate and use moment to moment data on student behavior and academic performance in a natural and intuitive manner enabling teachers to get a close and personal view of each student's learning journey. The system programs are used on tablets or other like devices.

### BACKGROUND OF THE INVENTION

As a social worker, working with school age children, their teachers, and parents, I became aware that many of the difficulties that students had in school were aggravated due to the practical inability of teachers and parents to carefully measure and respond to a child's specific needs on a day to day basis. Many of the therapeutic interventions rely on a teacher and/or a parent's ability to understand the challenges of a child on a simple level. For example, a teacher might identify the child's most disruptive or dysfunctional behavior or a child with impulsive behavior. The teacher/parent must then help the child simplify the problem into small manageable steps. One way to do this is to ask the child to try to control a specific impulse behavior for a short amount of time. The child needs to be encouraged and rewarded for succeeding in this small task. As the child learns to control the impulsive behavior for a short period of time, the teacher or parent will help the child stretch his or her ability to a longer period of time, and to other impulsive behaviors. A common problem is that the teacher has so much work to do that it is impossible for a single person to adequately observe and respond to more than one or two children at this level.

It has been well documented that a “positive environment” is critical in allowing a student to thrive. However, the elements that make up a positive environment are very difficult to measure and control. One of the common elements of a positive environment is the ratio of positive to negative communication between people. It is common that within one classroom, some students perceive to be in a “positive environment”, while others, in the very same room report that the environment is not positive at all. It is impossible for a teacher to keep record of every interaction with every child. It is also easy to comment on certain behaviors, which catch a teacher's attention (often negative), while non events, or even positive behaviors, are easily overlooked. There are other cognitive traps that contribute to a teacher's inability to monitor and respond to the many demands of each and every student. It is not uncommon for teachers to develop subconscious biases towards some students. These biases make it difficult for teachers to recognize progress. When a teacher fails to recognize a student's effort and progress, he or she feels very discouraged and often will relapse to old patterns of dysfunctional behavior.

It has been well documented that a person can only focus on one primary task at a time. Many teachers consider their primary task the delivery of information to the students. The problem is that many students are not “getting on board”, and when the “train leaves the station” many are left behind. Teachers do not have a tool that adequately measures student engagement in a way that does not interfere with the teacher's ability to teach.

In addition, it takes more than a teacher to help a student succeed. Students with a strong support network have a strong advantage when it comes to succeeding at school. A common problem that many students have is that even if there is a strong support network, there are many gaps that allow the students to slip through. Very often the very people in the support network do not have the time to adequately pass the necessary information to the people who need it. If pertinent information was automatically sent to the right people, many issues can be addressed in a more efficient manner.

A common challenge in classrooms today presents itself when students are pulled out of class for services like speech therapy, occupational therapy, tutoring, etc. While the students need these services, it also creates a challenging situation in that they are missing valuable classroom time. Since many students can be pulled out at various different times, it becomes nearly impossible to know what part of the lesson a particular student missed. Now, the student has the additional challenge of overcoming this hurdle. In addition, it is difficult to notice if students are spending more time out of class than necessary.

The invention provides an Educational Systems Software (ESS) product that has compelling advantages beyond what is available in the market today.

While many software applications have been written and implemented in past years for educational facilities, they have essentially provided an electronic means of recording and reporting the same data that had been previously maintained manually. The benefits have been seen in improved record keeping and access to data.

The present invention utilizes the recent advances in simplified data input and output devices (tablet computers) and large-scale data gathering to take Educational Software to the next level. Using the invention system will empower teachers, administrators, staff and parents by providing real-time information that can be used to gauge and adjust the interaction between the participants in and out of a classroom.

By providing instantaneous feedback with respect to various classroom situations, the instructor will be better equipped to respond in ways that are beneficial to the student and the teacher.

### SUMMARY OF THE INVENTION

In the present invention, these purposes, as well as others which will be apparent, are achieved generally by providing teachers with a system and tool that allow them to record and analyze important information that was previously impractical or unable to be recorded.

In particular the invention provides a computer program product for capturing real time behavior patterns of individual students to track the students progress and development of his/her true potential. The computer program product includes a tangible computer readable storage medium having computer readable program embodied therein.

The computer readable program code is configured to include a first interface with the layout of a classroom and students; a second interface with attendance indicators; a third interface with academic indicators; and a fourth interface with behavior indicators. The second interface, third interface and fourth interface are all in communication with the first interface such that the real time behavior patterns of the attendance, academic and behavior indicators of the individual students in the classroom are captured and complex output of the real time behavior patterns for each student is generated to track the student's progress.

The second interface includes attendance indicators selected from the group consisting of restroom, services, discipline, errand, quick break and excused events.

The third interface includes academic indicators selected from the group consisting of on the right track, incorrect, basic, advanced and others.

The fourth interface includes positive behavior indicators selected from the group consisting of kindness, decision, effort, encouraged, self control, answer and question and also includes negative behavior indicators selected from the group consisting of conflict, disruptive, no seated, unprepared, talking, distracted, other and conflict.

While specific examples of attendance, academic and behavior indicators are listed above, other additional indicators are included within the scope of the invention which can be configured to encompass any changing requirements.

The computer program product generates complex output which is used by the respective teacher to form action plans to address the individual student behavior. The complex output is generated as a pie chart, bar chart or graphic illustration and can be generated daily, weekly and monthly to track progress of the student.

The computer program product uniquely provides attendance, academic and behavior indicators that are color coded in different colors to visibly track the indicators for each student.

The invention also provides an educational system for tracking real-time behavior information of individual students including a computer program product which can be accessed by a computer tablet. The teacher accesses the computer tablet and tracks real-time behavior information of each individual student on the tablet, and the information gathered is used to gauge and adjust the interaction between the students and teacher in and out of a classroom.

The education system includes a computer program having a first interface with the layout of a classroom and students; a second interface with attendance indicators; a third interface with academic indicators; and a fourth interface with behavior indicators. The first interface is in communication with the second interface, third interface and fourth interface such that the teacher swipes and taps on a student icon to capture the real time behavior patterns of the attendance, academic and behavior indicators of each individual student in the classroom.

The education system also generates complex output of real time behavior patterns to track a student's progress. The complex output generated is used to form action plans by the teacher to address student behavior. The complex output is generated as a pie chart, bar chart or graphic illustration and can be generated on a daily, weekly and monthly to track progress.

The education system uniquely provides attendance, academic and behavior indicators that are color coded in different colors to visibly track the indicators for each student.

The invention assists teachers in identifying behavioral trends of the students and to maintain a close eye on subtle changes of those trends. It also helps teachers identify strengths and weaknesses in students and measure whether their interventions are producing a desired effect. The invention also lets teachers break down overwhelming challenges into simpler, less intimidating challenges.

An advantage of the invention is in the provision of an educational system wherein a teacher utilizing a computer tablet, tracks real-time behavior information of each individual student on the tablet. The information gathered is used to gauge and adjust the interaction between the students and teacher in and out of a classroom.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is an illustration of the attendance recording functional flow according to the invention;

FIG. 2 is an illustration of the behavioral event recording functional flow according to the invention;

FIG. 3 and FIG. 4 are illustrations of the layout of the classroom and students according to the invention;

FIG. 5 is an illustration of the attendance, academic and positive behavior and negative behavior indicators according to the invention;

FIG. 6 is an illustration of the complex output according to the invention; FIG. 6A illustrates an interaction timeline; FIG. 6B illustrates a behavior bar chart; FIG. 6C illustrates an attendance pie chart; and FIG. 6D illustrates an attendance timeline; and

FIG. 7 is another illustration of the complex output according to the invention; FIGS. 7A, 7B and 7C illustrate the academic dashboard by week, by day and by month, respectively.

### DETAILED DESCRIPTION OF THE INVENTION

In accordance with the present invention a computer program product for capturing real time behavior patterns of individual students is provided to track the student's progress and development of his/her true potential.

The invention utilizes a unique model of learning referred to herein as APEX. APEX is an acronym that stands for Attendance, Preparedness, Engaged, Challenged and Succeeded. (The X is broken down to a CS). For a student to learn, they must go through these steps in this order.

Attendance: In most schools, attendance is marked at the start of the class, but if a student steps out, there is no record if that. The invention system redefines attendance to mean that the student is actually attending the class at that moment.

Preparedness: Many students' struggle can be traced back to coming unprepared. A student can be unprepared in several ways. A few examples: a student might not have the proper supplies or books, a student might not have done the homework the night before, a student might have something else on his/her mind, etc. In all of these cases, the root of the problem is coming unprepared, and without addressing that component, it is unlikely that any intervention will provide a desirable outcome. The invention system encourages teachers to indicate whether a student is unprepared in any way, and will identify recurring patterns when applicable.

Engaged: This is the primary function of the invention system. It measures the kinds of engagement and helps guide teachers to engage all of their students in ways that have been proven to foster positive and working relationships.

Challenged and Succeeded: If a student is never challenged, he will get bored and lose focus. If a student never succeeds, he will feel like a failure and give up. For students to thrive and grow they need a diet that blends challenge and success. This is a common sense concept that has been well researched. Although not fully integrated into the system yet, this feature will allow teachers to tailor exams to each student's strengths, based on how they were engaged during the lessons. Teachers will know what questions students were able to answer during class so they can make sure that each student is feeling that their effort pays off for them. This will be accomplished through the use of our dynamic lesson planner that seamlessly ties all of the student engagement information to the teacher's lesson plan, and specialized reports that show incremental progress.

To accomplish this the invention provides a computer readable program code configured to include a first interface with the layout of a classroom and students; a second interface with attendance indicators; a third interface with academic indicators; and a fourth interface with behavior indicators. The second interface, third interface and fourth interface are all in communication with the first interface such that the real time behavior patterns of the attendance, academic and behavior indicators of the individual students in the classroom are captured and complex output of the real time behavior patterns for each student is generated to track the student's progress.

The invention also provides an educational system for tracking real-time behavior information of individual students including a computer program product which can be accessed by a computer tablet. The teacher accesses the computer tablet and tracks real-time behavior information of each individual student on the tablet, and the information gathered is used to gauge and adjust the interaction between the students and teacher in and out of a classroom.

The program is set up to have the layout of the classroom. Each student has his/her picture in the place where he/she sits in the room. The picture has a color coded border to reflect the ratio of positive to negative events that were recording for each particular student. A student with an inadequate ratio will show the teacher that this particular student needs to be engage in a positive way, or get “caught doing something good”. By making sure that they engage students in a very positive way, teacher can earn the trust and respect of their students. There is also a positive event meter that keeps track of the number of positive events that were recorded in the last two days by this teacher. This ensures that even student's who do not record negative attention, still are engaged in a positive way on a regular basis. Every event that is recorded is labeled with a description and an intensity measure. If a student has a significant decrease in frequency or intensity of a particular misbehavior, the program will alert the teacher to acknowledge this progress to the student. The data will also be analyzed to identify trends that help understand a student's difficult times and other variables that might contribute to his/her struggle.

The interface is a simple grid with each student in a place that matches the classroom layout. To record a positive event, the teacher swipes up on the student's face and a menu of positive events are displayed. The teacher simply taps the event that matches the observed behavior.

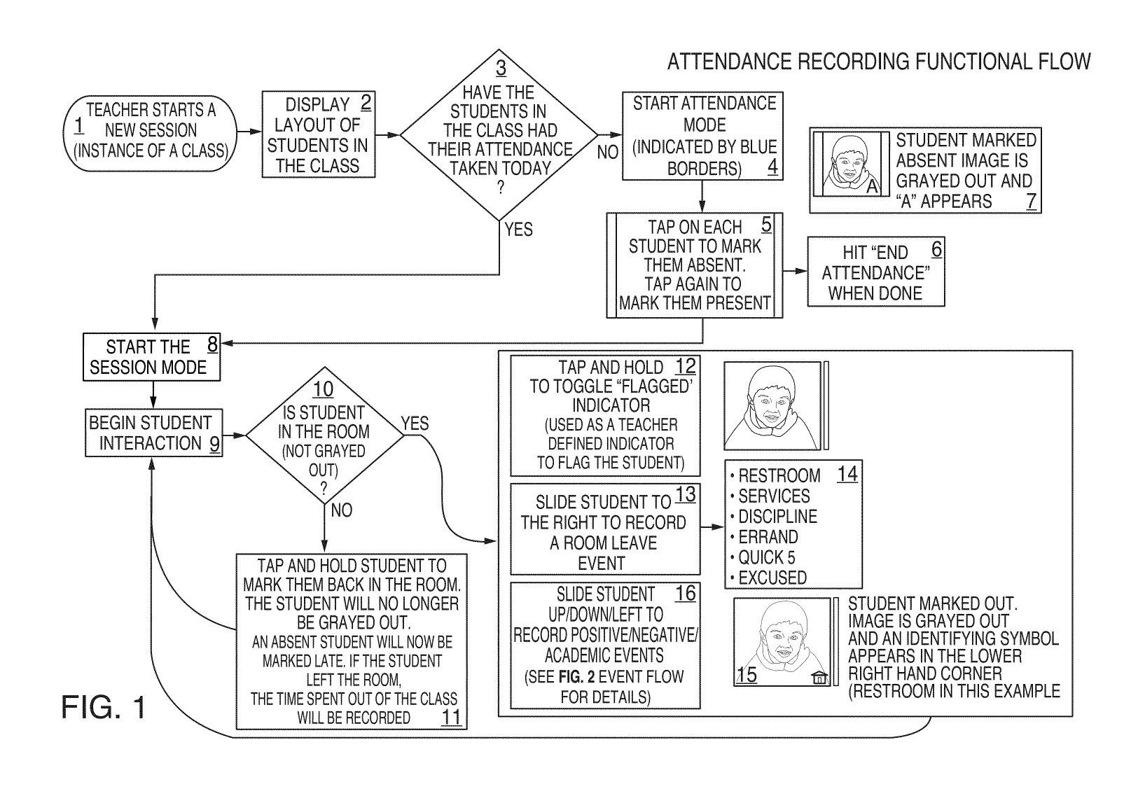

FIG. 1 illustrates the attendance recording functional flow of the invention. At the beginning of a class the teacher starts a new session 1 on the tablet. The display layout of the students in the class 2 appears on the tablet. Daily attendance is taken 3 with the teacher starting the attendance mode 4. The teacher taps on each student to mark them absent and taps again to mark them present 5. When the teacher is done with the attendance they hit “end” 6. When a student is marked absent, their respective image is grayed out and an “A” appears 7.

Once attendance is taken, the teacher proceeds to the start session mode 8. The teacher-student interaction begins in the classroom 9. The teacher uses the program track to whether the student is in the classroom or not 10.

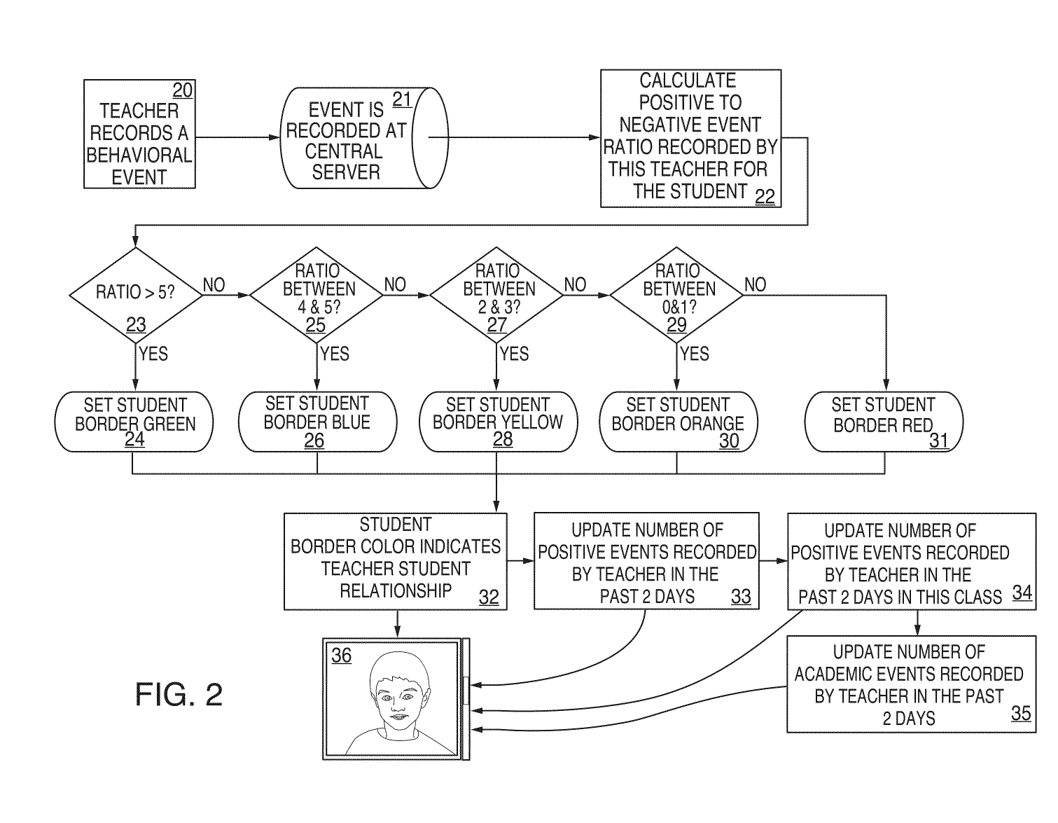

If the student is in the classroom (image not grayed out) the teacher can tap and hold toggle “flagged” indicator 12. This indicator is used as a teacher defined indicator to “flag” the student. The teacher can slide the student to the right to record a “room leave” event 13. The “room leave” event can include, but is not limited to, restroom, services, discipline, errand, quick 5, excused 14. If a student is marked “out” the image is grayed out and an identifying symbol appears in the lower right corner (“restroom” as illustrated in FIG. 1) 15. The teacher can also slide the student up, down and left to record a positive/negative/academic event 16. FIG. 2 illustrates a behavioral event recording functional flow chart describing these positive/negative/academic events in more detail.

If the student is not in the classroom, the image is grayed out, the teacher taps and holds the student to mark them back in the room 11. The student will no longer be grayed out. An absent student will now be marked out. If the student left the room, the time spent out of the class will be recorded.

FIG. 2 illustrates the behavioral event recording functional flow according to the invention. The teacher records a behavioral event 20, the event is recorded at central server 21. The positive to negative event ratio is calculated by the program and recorded for the student 22 and is color coded. If the ratio of positive to negative events is greater than 5, 23 than the student border is set to a green color 24. If the ratio is between 4 and 5, 25 than the student border is set to a blue color 26. If the ratio is between 2 and 3, 27 than the student border is set to a yellow color 28. If the ratio is between 0 and 1, 29 than the student border is set to an orange color 30. If there is no behavioral event the student border is set to a red color 31.

The student border color is used to indicate the teacher/student relationship 32. The program updates the number of positive events recorded by the teacher in the past 2 days 33. The program updates the number of positive events recorded by the teacher in the past 2 days in this class 34. The program updates the number of academic events recorded by the teacher in past 2 days 35. The color coded borders are easily visible next to the respective student icon. While the program has designated certain colors with certain ratios it is within the scope of the invention to change these colors if so desired.

The invention is meant to empower teachers to understand each student's unique learning process and to enable the child's teacher to have a positive relationship with the child and every other student in the classroom. The invention amplifies the teacher capabilities through the smart use of tablet technology.

Capitalizing on the functionality and portability of tablets, the invention program allows teachers to easily keep a running account of classroom goings on. This powerful data is then made graphically available both in and out of the classroom. In the classroom, simple visual feedback balances a teacher's attention in ways not previously possible. Outside the classroom, educators have access to an array of intuitive tools which graphically present important trends and statistics.

The invention has two core properties: 1) Simple Input, and 2) Complex Output. Through touch technology, data input now takes negligible time and effort, making it feasible to easily capture far more information than ever possible. The unique data generated allows for complex output of both immediate and long-term feedback relevant to the classroom. The next two sections will provide a tangible description of this input and output.

### Input

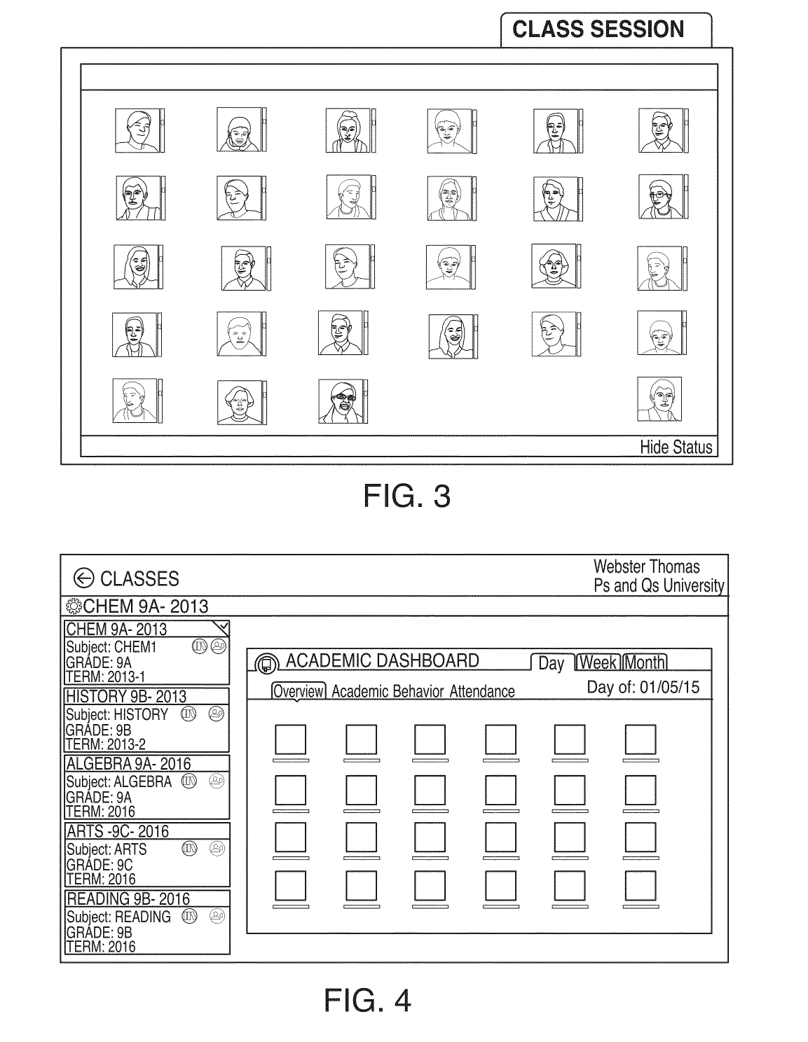

The invention system is designed to allow teachers to input data in a second or less. Input is completely tablet-based and a momentary tap records a data point. The quick input is directly related to the layout and configuration of the invention. In particular FIG. 3 illustrates the layout of the classroom and students according to the invention. FIG. 4 further illustrates the academic dashboard according to the invention showing the layout of the classroom and the students. The dashboard includes tabs entitled overview, academic, behavior and attendance. Various time periods can also be viewed, by day, week or month.

The invention program provides color coded borders and meters which allow teachers to visibly keep track of praise and critiques providing continuous visual feedback on each student in real time. This data is critical for maintaining effective relationships to motivate students.

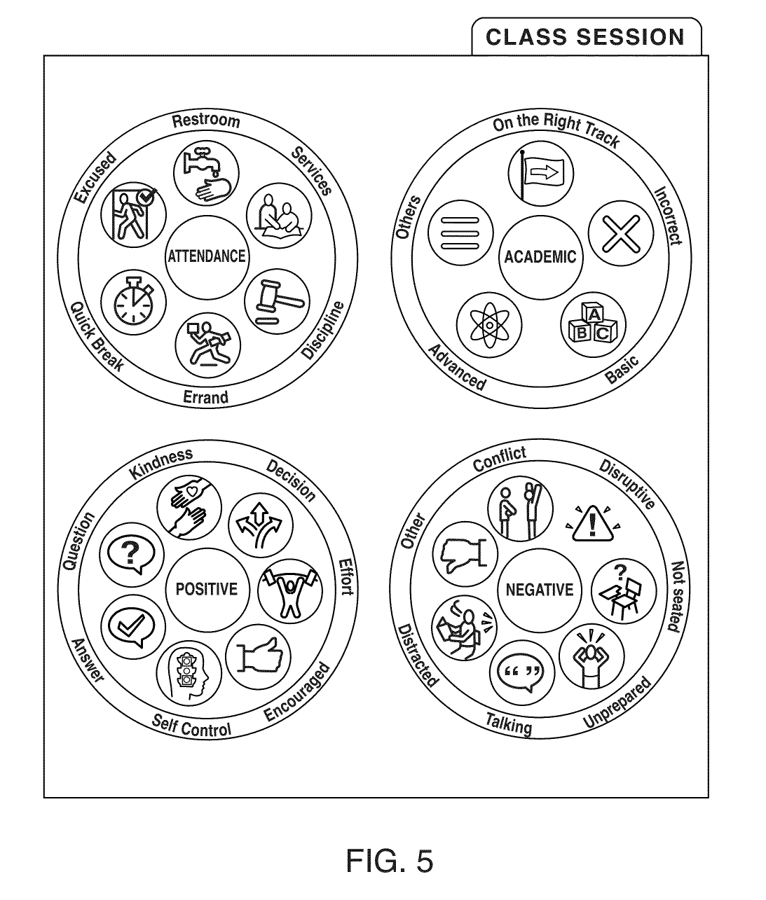

FIG. 5 is an illustration of the attendance, academic and positive behavior and negative behavior indicators according to the invention. The computer program provides the ability to control the lists of attendance, academic, positive behavior and negative behavior indicators using external configuration in order to react to any additional changing requirements. As shown the attendance indicators include restroom, services, discipline, errand, quick break, excused. The academic indicators include on the right track, incorrect, basic, advanced and others. The positive behavior indicators include kindness, decision, effort, encouraged, self control, answer and question. The negative behavior indicators include talking, distracted, other, conflict, disruptive, not seated, unprepared. Other indicators which may be contemplated are within the scope of the invention.

Some basic examples of fast input by the teacher relating to a student's activity are as follows.

A student is actively involved. The teacher swipes the student's onscreen seat upward—in the same location as in the real classroom—and taps on “active involvement” on the positive events menu that pops up. A “hit” (a positive incident) is recorded. Total time: ˜1 second.

A student is disturbing a peer. A swipe downwards and a tap on “peer disturbance” on the negative events menu records a “miss” (a negative incident). Total time ˜1 second

A student leaves the room for tutoring. Her seat is swiped in the direction of the door, “services” is tapped, and her seat deactivates. Upon reentry, a double tap reactivates her seat. Length of time out and purpose of leaving is automatically entered in a database. Total time ˜1 second

A teacher has a positive interaction with a student. Swipe up, tap “positive interaction,” and done. Total time ˜1 second.

The invention is designed to make this data entry intuitive, and most importantly, minimally intrusive to the teacher. To use the invention, each teacher uses a tablet while teaching. Lesson material is all synced to the tablet. The class itinerary is on the tablet. The tablet goes wherever the teacher goes functioning like a second hand.

The benefits of all this data input, as the next section will demonstrate, are tremendous.

### Output

The kind of microscopic data recording we described, allows the invention system to generate all sorts of crucial and previously unavailable output—information which can literally transform teacher-student interaction on a grand scale.

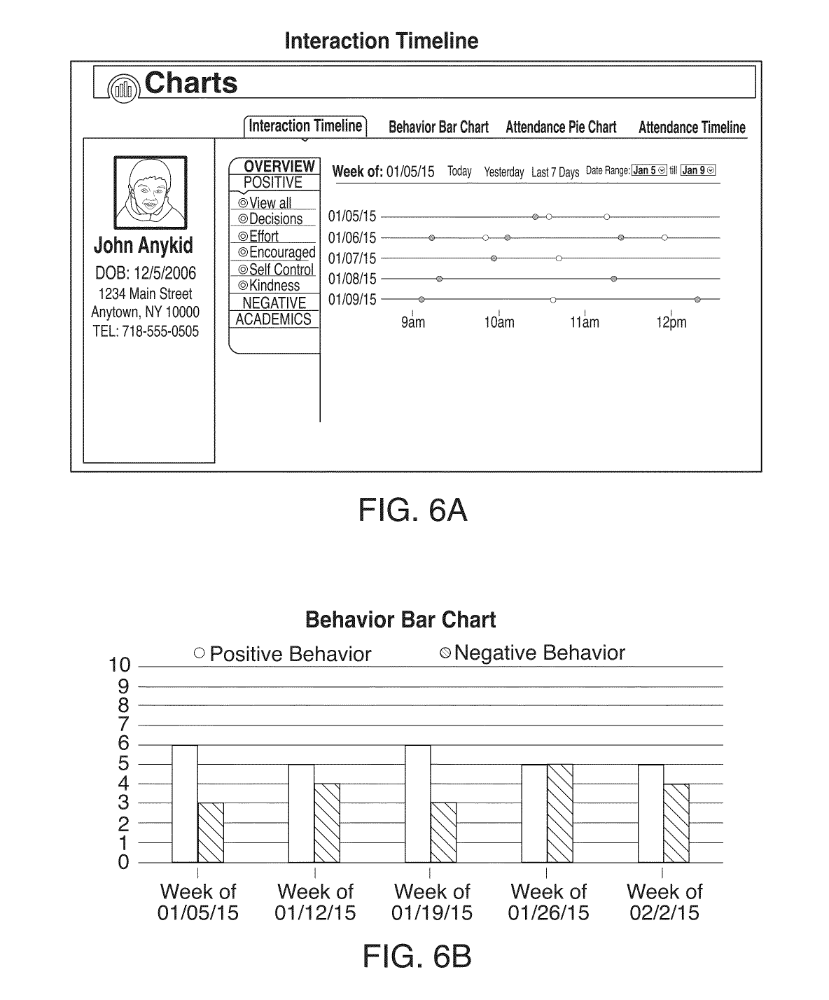

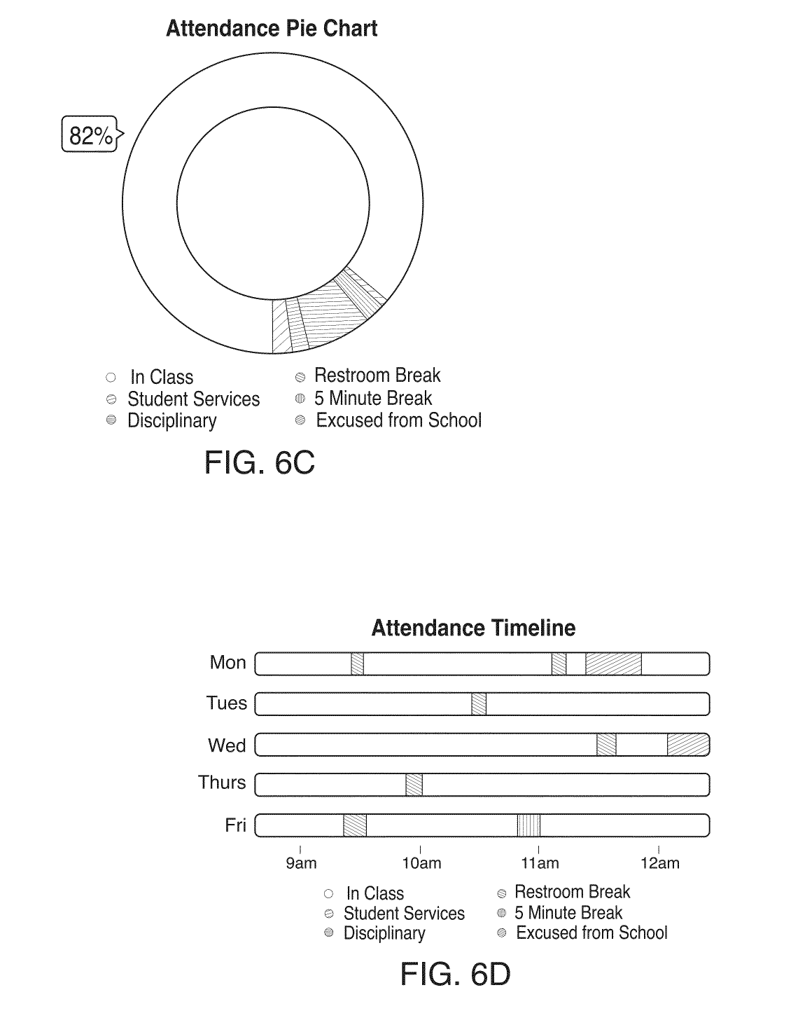

FIG. 6 is an illustration of the complex output according to the invention. The invention provides real time, real focus and real results. The behavior patterns of a student are visible at a glance. Clear depiction of students behavior patterns provide the teacher to focus efforts on helping the students' achieve their full potential. In particular FIG. 6A is an interaction timeline which is a detailed report to every positive and negative behavior and the time it occurred. This gives the teacher a clear picture of each students' behavior patterns so that a definitive action plan to address the behavior as required can be formulated. FIG. 6B is a behavior bar chart that illustrates week by week totals of positive and negative behaviors. This helps the teacher identify incremental progress and other behavior trends. FIG. 6C is an attendance pie chart that gives the teacher a quick snapshot of the percentage of time that a student spends in and out of class, with a breakout of why the student was not in class. FIG. 6D is an attendance timeline with the same information as in the pie chart but in daily, minute by minute form. This enables the teacher to know what lessons students missed, which lessons require make-up and how to score tests accordingly.

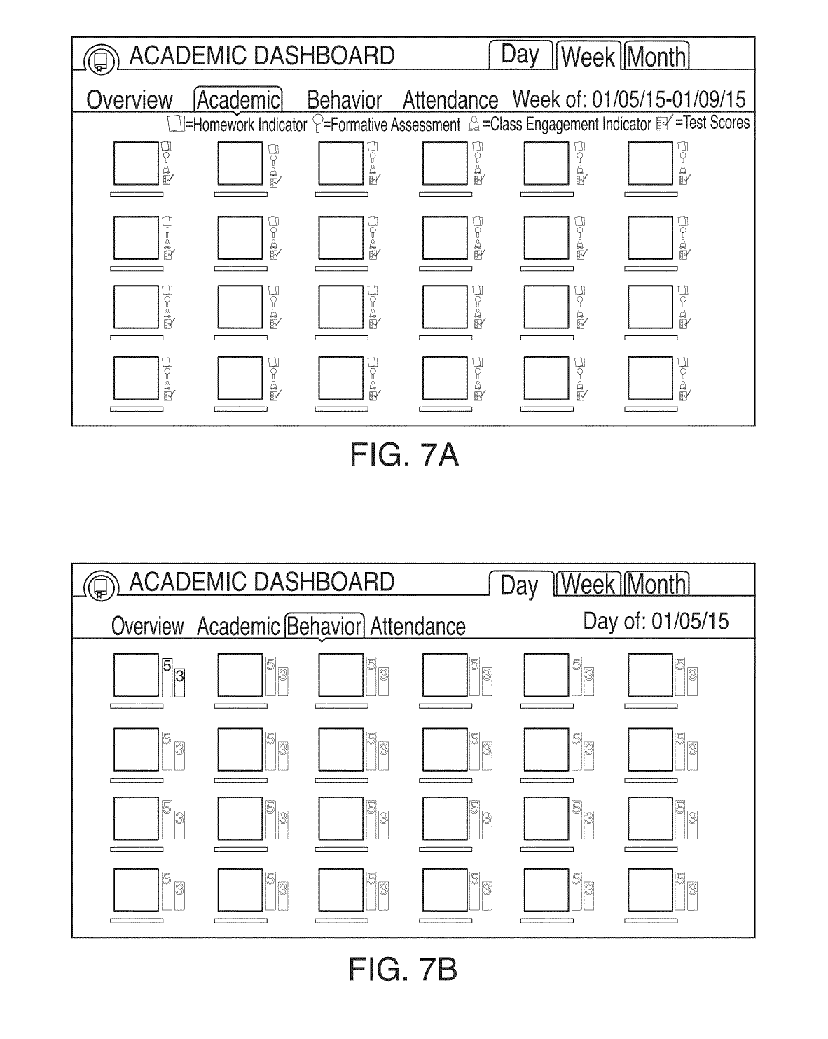

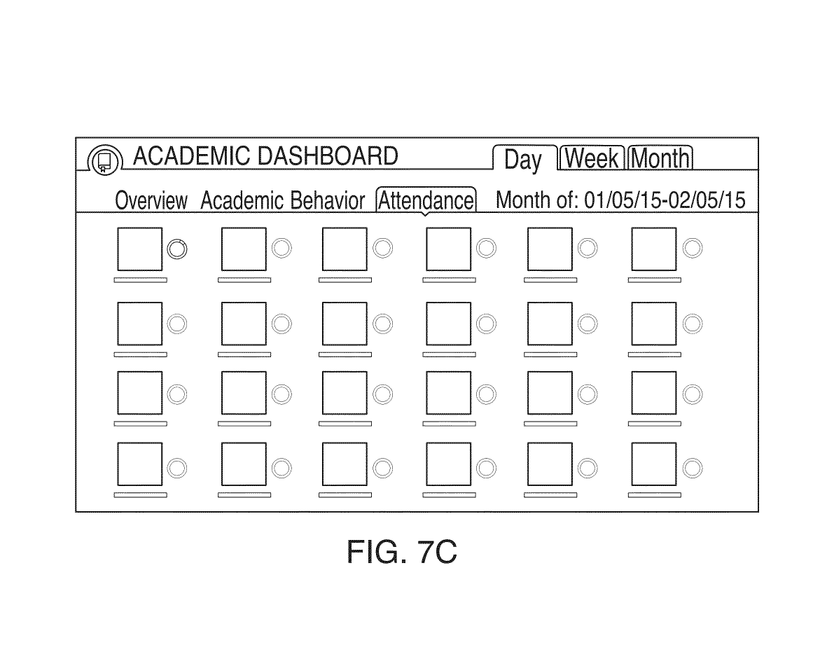

FIG. 7 is another illustration of the complex output according to the invention. In particular FIGS. 7A, 7B and 7C illustrate the academic dashboard by week, by day and by month, respectively.

### Teacher-Student Relationships

Teacher-student relationships matter. Many of us can warmly recall those teachers with whom we shared a positive relationship and its impact on our motivation and success in school. Unfortunately, we can also remember those with whom we had negative relationships. Aside from such personal experience, abundant research clearly demonstrates the importance of teacher-student relationships to student success. What effect might it have if every student generally had a positive experience in the classroom?

Extensive research has demonstrated that good relationships maintain a ratio of 5:1 positive-to-negative interactions. This holds true for marriages, for business teams, and even for one's relationship to oneself. Expecting a teacher to keep tabs of whether her relationship with each of 25 students has been 5:1 positive or even just generally positive is quite challenging.

The invention system automatically tabulates the data entered and computes a positive-to-negative ratio. The border of a student's seat changes colors to reflect relationship status.

The teacher's interactions with Clara have been largely negative over the past two weeks. The border around Clara's seat changes from green, to blue, to yellow, than to orange, and finally to red. This is easily noticed and the teacher goes out of his way to interact with Clara positively. Over the next couple of days her seat color moves slowly back to green, or >5:1 territory.

This cue provides a concrete stimulus for the teacher to keep students “in the green”, i.e., on the positive side.

### Balancing Classroom Interaction

Consider the following example:

During a given period 13 students participated in the class discussion. In the next session, 11 students asked question or gave answers. There are 25 students in the class. Chris is one of a number of students who don't participate often. With such numbers it is impossible for a teacher to keep a precise running tab of who is engaged and who is slipping by. But not anymore, with the invention program, a one second tap is all it takes.

This kind of comprehensive information gathering allows for patterns to be detected. Normally it may have taken a month or more for a teacher to notice a quiet student not succeeding—more often than not when the student performs poorly on the occasional test. With the invention a glance at a simple week-end graph report shows an educator who has not been participating. It becomes immediately obvious where intervention is needed. But the invention does even more:

After a few days of non-participation the invention system floats a bubble on top of Chris's seat. A peek is all it takes to notice “bubbled” students and intentionally engage them. The teacher's input is used automatically to assist her in balancing student engagement without any added difficulty for her.

### Incremental Progress (“Invisible Progress”)

Progress occurs incrementally, but in a large class, we only notice big strides. Too often however, a student makes small strides or even significant progress, but because he is still far from a desired goal his progress goes unnoticed. Students often get discouraged when these efforts go unacknowledged. We call this “invisible progress.” The invention addresses this by automatically alerting the teacher, or other appropriate educator, as soon as any significant change occurs in any area. The teacher can then reinforce these small steps and increase the likelihood of big strides. Take this scenario:

Tom has a tendency to disturb the class. His teacher is understandably annoyed by Tom's disturbances. He has repeatedly talked to Tom, but Tom is still disturbing the class. Tom's teacher is becoming more and more annoyed.

Tom has been working very hard not to disturb and has dropped from four disturbances per period to two. He is frustrated that his teacher does not notice his efforts and out of discouragement he begins to revert to his old behavior.

Tom is still far from ideal behavior, i.e., no disturbances. While teaching 25 students, it is very hard for a teacher to track incremental changes in how many times a given student disturbs. Teachers often grow more and more biased against “disturbers” while they may be genuinely trying to improve. The invention is the net that catches these incremental changes which lie outside of human awareness.

After a few days, Tom's teacher is automatically notified that Tom's disturbances have decreased. The teacher calls Tom aside and recognizes his effort and encourages him to “keep up the good work,” and can even show Tom by how much his behavior has increased. Tom is encouraged and feels noticed. He intensifies his efforts and shortly stops disturbing totally.

Often all it takes is just to say “I noticed.”

### Recognizing Non-events

It is easy to notice when an “event” happens, e.g., a question, leaving the class, or fighting with a classmate, but what about when nothing has happened? What if a student stops asking questions, stops misbehaving, or just hasn't had any significant interaction with the teacher at all for weeks?

Jeremy has been cruising along, participating occasionally, but has not interacted with the teacher in two weeks.

This is “invisible regress.” The invention system “notices” these kinds of non-events and communicates them when significant.

### Catching Problems Early

Any teacher knows it is far easier to stop a problem in its early stages, say at a severity of 4/10 vs. 7/10. It is also far harder to notice a problem in its early stages. The invention is designed with this in mind.

Jenny has taken to staying out longer and longer on her “bathroom breaks.” She is a quiet girl and this typically would go unnoticed for a while—maybe until it starts harming her grades. Not with the invention system. As soon as this becomes somewhat significant, the teacher is notified. Jenny's teacher talks with her and realizes she is ahead of the class. She provides Jenny with additional responsibilities. Jenny feels proud and the problem is nipped in the 4/10 stage.

Richard's test scores have dropped significantly. He has ADHD and has taken increasingly to distracting himself with his iPhone under his desk. The invention system brings this to the teacher's attention, who can work out a plan with Rich.

### Accountability and Itinerary Tracking

The inventions' running account of the classroom allows teachers to hold students accountable in a fair and informed manner. Take Richard from the previous example. Teachers often have agreements with students with ADHD, like Rich, whereby they can signal the teacher and leave the room when they need a break. Often this privilege gets abused, or even just allows Rich to “stay put in his ways.”

Richard's teacher cannot keep track of exactly how long he was out for, nor at exactly which times. He suspects that the breaks have been getting longer but it takes a while till he catches on. By this time, Rich's performance is suffering.

With the invention the teacher can easily note when Rich leaves and when he reenters by swiping him out. The teacher can set goals with Rich, and easily track those goals. He encourages Rich to shorten the breaks or to take them later in the class and can show him a graph of his progress. Rich slowly develops the ability to stay in class and engage in the lesson.

Or suppose a student leaves the room for speech therapy, special education, or a social skills intervention. After scoring a 65 on a test the next week, he says he missed part of the test material when it was covered in class as he was out for therapy. The invention system solves this problem. A built in itinerary planner allows the teacher to move through their lesson as it is being delivered. If a student steps out, the system notes exactly what was covered in the interim. An email is sent to the student's parent or tutor notifying them, and the student's record is notated. By pressing one button, the teacher can print pre-test study sheets for students showing them exactly what they missed.

Travis's speech therapy makes it hard for him to be present during a whole week's classes. His teacher was disappointed at his dismal performance on tests and Travis was getting more and more discouraged. His school began to use Class Act. The program allowed the teacher to see exactly what Travis was missing, and send him specialized study sheets with links to the material missed. Travis felt this was a reasonable arrangement which he could handle and his scores began to pick up.

Detecting Patterns

With the invention system, patterns that were previously unnoticeable can become clear, and easily remedied.

Different students tend to get fidgety at different points in a class. One student may take time to settle in, while another may get active towards the end. Some students may be more challenging in the morning, others in the afternoon. The invention system can graphically depict these patterns and schedule notification bubbles on top of a student's icon so the teacher can preemptively engage the student.

### Overriding Conscious and Unconscious Bias

The invention provides a significant degree of protection from teacher bias. Every teacher is a human being, and every human being tends to favor some people over others. One student may be cuter, sweeter, or better behaved than another. It is normally difficult not to give in to such bias and certainly challenging to notice when one is being affected by it subconsciously.

A strong point of the invention is how it combats such bias. It is hard to ignore concrete visual feedback which demonstrates one child is receiving far more than another. Assuming teachers good intentions—a generally fair assumption—making such imbalances in attention obvious can go a long way in creating a fair and balanced classroom.

The invention also preempts unconscious cognitive traps. Research shows that if a harsh sound occurs at the end of an otherwise superb musical performance, members of the audience will walk away with negative memories of the entire performance. Suppose a student tends to get fidgety at the end of class—a rather understandable phenomenon. A teacher is likely to walk away thinking this child was fidgety all day.

With the invention this kind of cognitive trap is avoided. When the teacher looks over the student's weekly report he can easily see that the student is actually generally far better behaved than many other students. He can also see that this student just gets antsy at the end of the period. Knowing this, he can arrange for the system to “bubble” the student's seat five minutes before the end of class, reminding the teacher to specifically engage this student.

An important side effect of this process is that the more a teacher is exposed to this type of objective data, the more cognizant she can become of memory and judgment biases. This awareness in turn reduces her susceptibility to them. For example, whereas before she looked for all-or-nothing improvement, she now can concretely see incremental change and come to appreciate it. She can also see how her memory of events is often distorted, such as in the “last five minutes effect” described in the previous paragraph.

While the invention has many useful features the following features are of considerable importance.

### USAP—Understanding Student As A Person

A crucial component of positive student-teacher relationships is the teacher's ability to have an understanding of the student as a person, to see his students' strengths—not just the difficulties students often present. Such a relationship requires that a teacher be familiar with and attentive to each individual student. In the invention system every child has a profile. The profile records their interests, family details, strengths, values, historical trends, and other relevant data, and renders this accessible in a tap or two. A teacher can quickly access information about students to engage and motivate them. Tapping on a student's picture raises a small bar with basic information. A teacher can use this information to personalize praise by glancing at the student's values and catching him actualizing them.

Chan's teacher notices Chan has been working very hard on math exercise and wants to give him personalized feedback. He taps Chan's icon and sees that one of Chan's values is persistence. The teacher points out to Chan how he is embodying this value through his hard work. Chan goes home feeling proud of his hard work.

Or consider a student who is passionate about music, or her local lacrosse team. The teacher can quickly note her favorite artists or players and then use a codeword that will grab the student's attention. This allows the teacher to avoid embarrassing the student by calling out her name, and motivates the students through such personalized attention and familiarity. In general, when we have a better understanding of students as people it is easier for us to see them in a more positive light.

### Support Network Collaboration

It takes a village to educate a child. The teacher teaches the lesson. A parent or tutor might help with homework and reviewing for tests. Other professionals or family members may be enlisted to help a student succeed. Our application will keep track of a student's support network and facilitate efficient communication. This will ensure that the tutor always knows what her student learned in class that day, or better yet, what her student missed in class because she was taken out for speech therapy that day. It will help parents always know what's for homework. Applications that are targeted specifically towards parents, independent contractors, other members of a student's support network, and the student herself, can ensure that everyone is equipped with the necessary information that is crucial to a child's positive schooling experience. Email, social media, SMS messaging and other effective forms of communication will be integrated to allow teachers to keep track of their communications and responses. Automated alerts will notify the teacher if a parent has not responded within a period of time so that the teacher can follow up as needed.

The invention system has the potential to completely revolutionize education. Our systems will empower teachers, administrators, staff, and parents by providing real-time information that can be used to gauge and adjust the interaction between participants in and out of a classroom. With the invention system, educators will be better equipped to respond in ways that are mutually beneficial to the student and the teacher, to an unprecedented degree.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A computer program product for capturing real time behavior patterns of individual students to track the students progress and development of his/her true potential, the computer program product comprising: a tangible computer readable storage medium having computer readable program embodied therein, the computer readable program code configured to:
a first interface with the layout of a classroom and students;
a second interface with attendance indicators;
a third interface with academic indicators; and
a fourth interface with behavior indicators;
wherein said second interface, third interface and fourth interface are in communication with said first interface such that the real time behavior patterns of said attendance, academic and behavior indicators of the individual students in the classroom are captured and complex output of said real time behavior patterns is generated to track the students progress.

2. The computer program product according to claim 1, wherein said second interface includes attendance indicators selected from the group consisting of restroom, services, discipline, errand, quick break and excused events.

3. The computer program product according to claim 1, wherein said third interface include academic indicators selected from the group consisting of on the right track, incorrect, basic, advanced and others.

4. The computer program product according to claim 1 wherein said fourth interface includes positive behavior indicators selected from the group consisting of kindness, decision, effort, encouraged, self control, answer and question.

5. The computer program product according to claim 1 wherein said fourth interface includes negative behavior indicators selected from the group consisting of conflict, disruptive, no seated, unprepared, talking, distracted, other and conflict.

6. The computer program product according to claim 1, wherein said complex output generated is used to form action plans to address student behavior.

7. The computer program product according to claim 1, wherein said complex output is generated as a pie chart, bar chart or graphic illustration.

8. The computer program product according to claim 1, wherein said complex output is generated daily, weekly and monthly to track progress.

9. The computer program product according to claim 1, wherein said attendance, academic and behavior indicators are color coded in different colors to visibly track said indicators for each student.

10. An educational system for tracking real-time behavior information of individual students comprising:
a computer program product which can be accessed by a computer tablet,
wherein a teacher accessing said computer tablet, tracks real-time behavior information of each individual student on said tablet, and said information gathered is used to gauge and adjust the interaction between said students and teacher in and out of a classroom.

11. The education system according to claim 10, wherein said computer program includes a first interface with the layout of a classroom and students.

12. The education system according to claim 10, wherein said computer program includes a second interface with attendance indicators.

13. The education system according to claim 10, wherein said computer program includes a third interface with academic indicators.

14. The education system according to claims 10, wherein said computer program includes a fourth interface with behavior indicators.

15. The education system according to claim 11, wherein said first interface is in communication with a second interface, third interface and fourth interface such that the teacher swipes and taps on a student icon to capture the real time behavior patterns of said attendance, academic and behavior indicators of each individual student in the classroom.

16. The education system according to claim 11, wherein a complex output of said real time behavior patterns is generated to track a student's progress.

17. The education system according to claim 16, wherein said complex output generated is used to form action plans to address student behavior.

18. The education system according to claim 16, wherein said complex output is generated as a pie chart, bar chart or graphic illustration.

19. The education system according to claim 11, wherein said complex output is generated daily, weekly and monthly to track progress.

20. The education system according to claim 14, wherein said attendance, academic and behavior indicators are color coded in different colors to visibly track said indicators for each student.
